(19) United States
(12) Patent Application Publication
(10) Pub. No.: US 2006/0055673 A1
(43) Pub. Date: Mar. 16, 2006

(54) Voice output controls on a mouse pointing device and keyboard device for a computer

(76) Inventor: Whei Chyou Wu, Fremont, CA (US)

Correspondence Address: WHEI CHYOU WU, 41854 VIA SAN MIGUEL, FREMONT, CA, 94539, US

(21) Appl. No.: 10/942,272

(22) Filed: Sep. 16, 2004

(51) Int. Cl. G09G 5/08

(52) U.S. Cl. 345/163

(57) ABSTRACT

A mouse pointing device and keyboard device having voice output controls for the voice chat room is disclosed. In one embodiment of the invention, a computerized system comprises a computer connecting to the internet, a mouse pointing device, a voice input equipment, a voice chat room downloaded from Yahoo website. The mouse pointing device has at least one control to control the chatter's voice thru voice input equipment transmitted to the other chatters in the chat room thru the internet.

### FIELD OF THE INVENTION

This invention relates generally to a mouse pointing device and keyboard device for a computer, and more particularly to such devices having internet voice chat controls.

### BACKGROUND OF THE INVENTION

A number of companies provide voice chat service thru internet. Those services let people can chat with other chatters thru internet which is very convenient and with fun. A USA company—Yahoo Inc. is one of those companies providing such service and a lot of people worldwide have experienced and enjoyed such voice chat room already.

The present invention particularly is designed to provides more convenient controls when people voice chat in Yahoo chat room or the other similar chat room with same problem. People can enter Yahoo voice chat room from Yahoo Messenger or yahoo's website by using browser (i.e., Microsoft Internet Explorer). FIG. 1 shows a typical yahoo voice chat room window that is entered from yahoo's website. Zone(A) in FIG. 1 shows chatter's identifications (ID) or nicknames and zone (B) is the place where chatters can input character from keyboard and that input will be appeared in zone(C) which all the chatters can see. In the FIG. 1 also shows a “talk” frame (this is called talk frame throughout the present invention). Moving mouse cursor inside the talk frame then press down the mouse left button then the chatter's voice input from microphone can be transmitted thru internet to the other chatters in that chat room as long as the mouse left button is still pressed down. Any time the left button of mouse is released then the chatter's voice stops transmission. Because the yahoo chat room is designed for a number of chatters to voice chat which that's the reason why there is the design of talk frame. Whoever first gets the chance to press down the mouse left button on the talk frame before the other chatters in the chat room has the priority to talk, and only one chatter is allowed to talk at any time in the chat room. It makes sense to have a such design for the chat room designed for a number of chatters. The present invention is particularly for Yahoo voice chat room and any other voice chat room with talk frame design.

FIG. 1 also shows a selectable hands-free frame whose function can let the chatter output his voice without needing to press down mouse left button on the talk frame. The output voice can be transmitted out thru internet to other chatters as long as the output voice from the microphone is loud enough. When hands-free frame is chosen, any time the input voice is big enough will activate this function to transmit output voice. This means that the chatter can transmit his voice without keeping pressing down the mouse button, that's why the term “hands-free” was chosen. But there are some shortcomings with hands-free design. First, it is very difficult to keep constant input voice sound level, so the transmitted voice heard by the other chatters may not be continuous. Besides, any other noises such as fingers knocking on the keyboard, people talking around, environmental noise could trigger the function causing the unwanted voice transmission. It's very difficult to maintain good voice quality by using hands-free function in the chat room. Adding that, the voice quality will be demanded higher if music is played. And more, it will be tiresome for the chatters have to press down the mouse left button all the time while they still are talking, singing or playing music. Besides, the chatters are possibly doing some other things such as writing or viewing emails, doing data searching, keyboard key-in or viewing webpages when they are in voice chat room. Whenever the chatter wants to talk who has to locate the chat room window then active that window and then locate the talk frame and move the mouse cursor into the talk frame and press down the left button to talk. After finishing talking the chatter probably will move the mouse cursor to the previous unfinished job, the same procedure, the chatter has to find the previous window then active that window then moves the mouse cursor to the previous job. And next time the chatter wants to talk who has to repeat the same steps again as described above. Due to the fact that the chat is possibly continuously on and on, the above stated steps are repeated which is very tiresome for the chatter.

One typical mouse controlling system basically includes parts below: Mouse Sensors--->Mouse Controller--->Communication Link--->Data Interface--->Driver. Sensors will detect any status change of mouse movement and mouse button. If the changes are detected the mouse controller will send a packetized data through communication link to data interface controller then to the driver. The driver will decode the packetized data and execute the job as required. The same principle applied to the keyboard too. The keyboard controller detects the key activated will send a packetized data to the driver, then the driver interprets the data and execute the job as required. The present invention is not limited to any particular implementation of mouse pointing and keyboard device and driver.

### SUMMARY OF THE INVENTION

The main object of the present invention is to use the controls on the mouse pointing or keyboard device to directly control the execution and stop execution of the program linked to the talk frame of the chat room window. And, after the chatter finished talking the mouse cursor will be back to the previous job. So, the chatters can do other things and join the voice chat at the same time efficiently.

Another object of the present invention is to provide locking function of the talk frame, so the chatters don't have to press down the mouse left button all the time while talking.

Still another object of the present invention is to let the chatters still engage in the voice chat in the situation by the controls on the mouse or keyboard which the chatters can not or do not conveniently view the monitor.

### BRIEF DESCRIPTION OF THE DRAWINGS

FIG. 1 is a typical window of Yahoo voice chat room;

FIG. 2 is a computerized system according to one embodiment of the invention;

FIG. 3 is a computerized system according to another embodiment of the invention.

### DETAILED DESCRIPTION OF THE INVENTION

In The following detailed description of the preferred embodiments, reference is made to the accompanying drawings which form a part hereof, and in which is shown by way of illustration specific preferred embodiments in which the inventions may be practiced. These embodiments are described in sufficient detailed to enable those skilled in the art to practice the invention, and it is to be understood that other embodiments may be utilized and that logical, mechanical and electrical changes may be made without departing from the spirit and scope of the present invention.

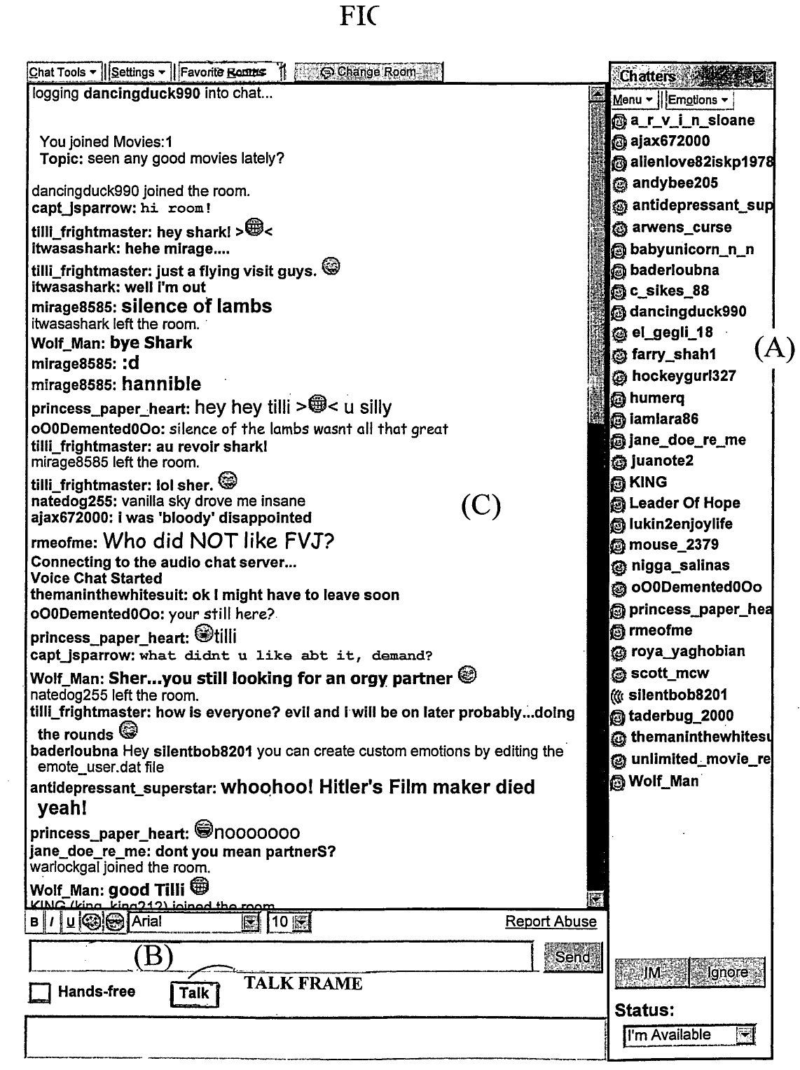

The window of Yahoo voice chat room can be downloaded from Yahoo messenger or Yahoo website. FIG. 1 shows a window of Yahoo voice chat room downloaded from Yahoo website and a talk frame can be seen.

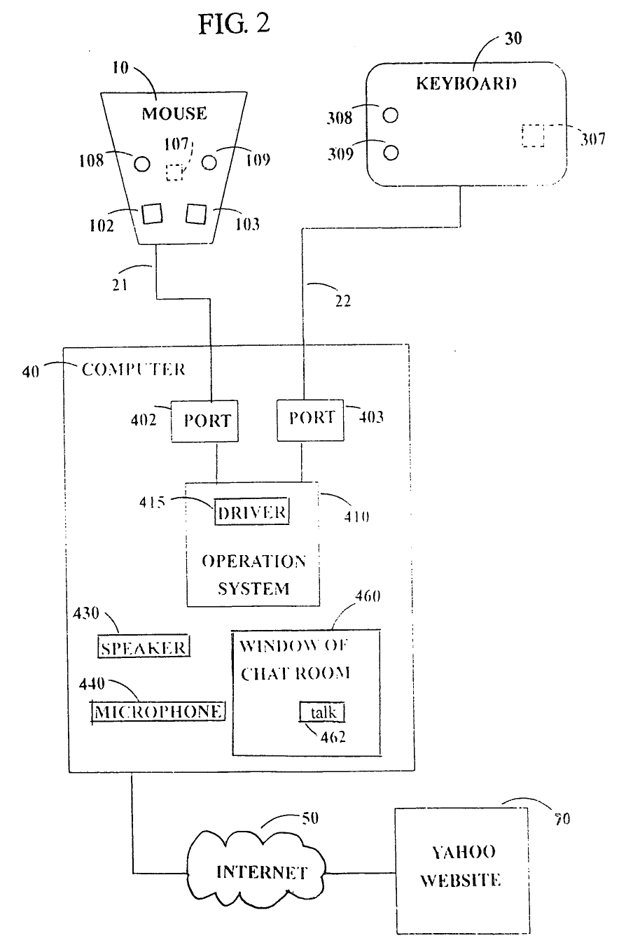

The goal is that we want to execute the program (is also called voice out program) linked to the talk frame or the program (is also called voice out program) which controls the chatter to transmit the voice from the voice input equipment (i.e., microphone) to the other chatters thru internet by the controls on the mouse point device (the controls on the mouse pointing device are also called mouse hot controls throughout the present invention) or the keyboard device (the controls on the keyboard device are also called keyboard hot controls throughout the invention). There are 3 possible cases. The first case is that the program source code has those HOT CONTROLS design. The activation of mouse or keyboard hot controls directly controls to execute the voice out program linked to the talk frame. Please referred to FIG. 2, the window of Yahoo chat room 460 is downloaded from Yahoo website 70 thru internet 50 and a talk frame 462 can be seen. The voice from other chatters can be heard from the speaker 430 thru internet 50 and the chatter's voice can be input into microphone 440 thru internet 50 to be heard by the other chatters. A mouse pointing device 10 and a keyboard device 30 thru connection elements 21, 22 connect to a computer 40 thru port 402 and 403 individually. FIG. 2 shows a popular 2-button (or 2-control) mouse pointing device on which there are a left button (i.e. control) 102 (the left button of a mouse is also called the first button of the mouse throughout the present invention) and a right button 103 (the right button of a mouse is also called the second button of the mouse throughout the present invention) and 2 controls 108, 109 (the 2 controls are also called mouse executing hot controls throughout the present invention) and a mouse controller 107 built on the circuit board inside the mouse. FIG. 1 also shows a keyboard device 30 with 2 controls 308, 309 (2 controls are also called keyboard executing hot controls throughout the present invention) and a keyboard controller 307 built on the circuit board inside the keyboard. For simplicity, the mouse and keyboard circuit board are not shown in the FIG. 2. The mouse pointing device 10 and keyboard device 30 are coupled to computer 40 as represented by element 21, 22 individually. The invention is not limited to a particular implementation of elements 21, 22. In one embodiment, elements 21, 22 represent a wireless connection, in which cases each of devices 10, 30 and computer 40 includes a radio frequency (RF) transceiver to communicate with the other transceiver. The transceiver for computer 40 is plugged into ports 402, 403 individually or replaces ports 402, 403 individually. In another embodiment, elements 21, 22 represent Universal Serial Bus (USB) cables of mouse pointing device 10 and keyboard device 30 plugging into ports 402, 403 individually, which are USB ports.

When the mouse or keyboard executing hot control 108, 308 is activated, the mouse controller 107 or 307 responds the activation by sending a packetized data thru element 21 or 22, thru ports 402 or 403 to driver 415. The driver 415 decodes that packetized data and then executes that voice out program. The mouse or keyboard hot control 109, 309 is used to stop the running voice out program. The function of mouse executing hot controls 108, 109 can be done on just one control. For example, activation of mouse executing hot control 108 performs to execute voice out program and then activation of control 108 again stops execution of that voice out program and take turns in that order. This principle applies for the keyboard hot controls 308, 309 too.

The second case is that the program source code doesn't provide HOT CONTROLS design. When the chatter wants to talk who has to locate and active the window of the Yahoo chat room by mouse or keyboard, and then moves the mouse cursor into the talk frame in that window and presses down the mouse left button to execute the voice out program linked to that talk frame. So we have to find out and record the executable location or route of the voice out program then use the controls on the mouse pointing or keyboard device directly control to execute or stop executing that voice out program. The chatters might have experienced that if we move the mouse cursor to the talk frame and then press down the mouse left button to execute the program linked to the talk frame, then next time just pressing down the spacebar of the keyboard can perform the same job as long as that command is not changed. It's executable location has been recorded. The second case is different from the first case is that we have to find out and record the executable location or route of the voice out program linked to the talk frame. We can design a procedure (the procedure is also called locating procedure throughout the present invention) and/or program (the program is also called locating program throughout the present invention) to record the enough information we need to find the executable position or route of the program linked to the talk frame. Some information such as the name and ID of the chat room, the location of the talk frame associate to the chat room, the absolute location of the chat room associate to the display etc., enable us to find the window of chat room even it is covered under by other window, then active that window and find out the location of talk frame then to execute voice out program linked to that talk frame. There are different ways to design locating procedure and/or program, and the present invention is not limited to any particular locating procedure and/or program.

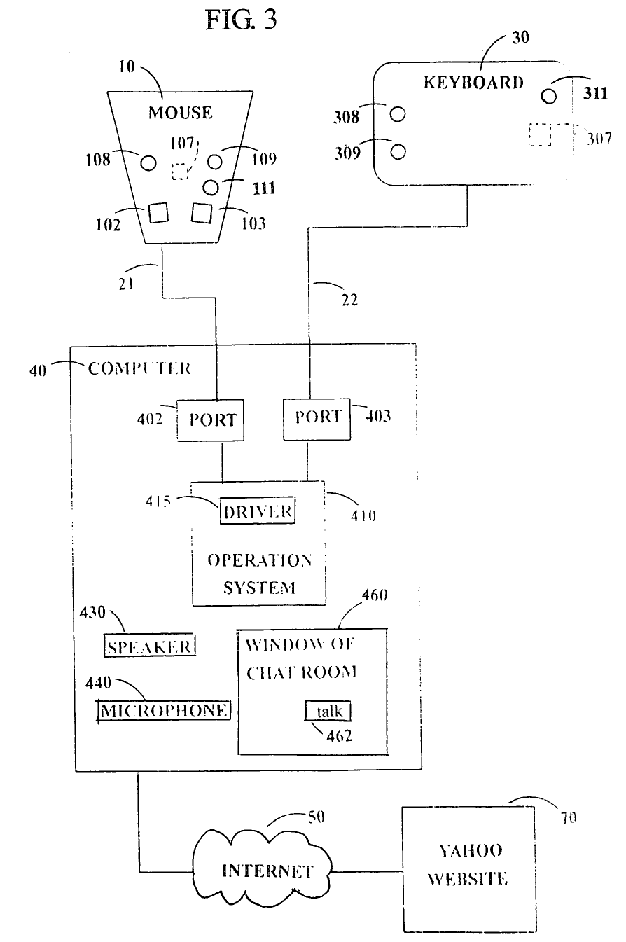

It would be much convenient that the locating procedure and/or program can be executed and stopped by the activation of the controls on the mouse and keyboard device (the controls are also called mouse locating hot controls, keyboard locating hot controls throughout the present invention). When the activation of locating hot controls is detected the mouse or keyboard controller responds that activation to send a packetized data thru connection element and port to the driver inside the computer, the driver decodes the data then executes or stop the locating program. To execute and stop the locating procedure and program can be performed by two separate hot controls or can be performed by only one locating hot control. Two locating hot controls design is that the activation of one control to execute locating procedure and/or program while the activation of the other control stops that. One locating hot control design is that first activation of that control execute the locating procedure and/or program and then activation of same control stops that locating procedure and/or program so on in that order. Please view FIG. 3 which comes from FIG. 2. Just adding a mouse locating hot control 111 and a keyboard locating hot control 311 and a program to start locating procedure and/or program 44 and a program to stop the locating procedure and/or program 45 to FIG. 2 which becomes FIG. 3. The window of voice chat room 462 is downloaded from Yahoo website 70 thru internet 50. The controller (mouse or keyboard) detecting the activation of hot button 111 or 311 will send a packetized data thru element 21 or 22 and thru port 402 or 403 to the driver 415. The driver 415 interprets the data then it will run a program 44 to start the locating procedure and/or program. When the hot control 111 or 311 is activated again, then driver 415 will run a program 45 to stop that locating procedure and/or program. In this embodiment in which just use only one hot control 111 or 311 to perform 44 and 45 to start or stop the locating procedure and/or program. This also can be done by using 2 separating buttons. Once the voice out program linked to the talk frame is located (the executable location or route is known) then the chatter can activate executing hot control 108 (on mouse) or 308 (on keyboard) to run that voice out program any time the chatter wants to talk thru internet and the chatter can activate executing hot control 109 (on mouse) or 309 (on keyboard) to stop running voice out program. As explained as the previous embodiment, the function of controls 108 and 109 can be performed just on one control. And same principle applies to the hot key 308 and 309 of keyboard.

The third case is that if the voice out program linked to talk frame of the chat room can be saved in the memory (RAM or Hard Disk), we can directly run that voice out program by activation of the mouse or keyboard hot controls any time we are chatting.

The present invention will remember the location or route of the previous job, the mouse cursor will jump back to the previous job when the chatter stops the talking.

The invention is not limited to the types of hot controls (those include executing hot controls and locating hot controls) included within mouse pointing device 10 or keyboard device 30. Such controls include buttons, wheels, sliders, etc. And, the present invention is also not limited to the types of button, wheels, sliders, etc.

For the mouse with only one executing hot control 108 and no locating hot control the control 108 is the third control of 3-control mouse or the third or fourth control of 4-control mouse or the third or fourth or fifth control of 5-control mouse and so on. For the mouse with 2 executing hot control 108, 109 and no locating hot control which the button 108, 109 is the third or the fourth control of 4-control mouse. And the control 108, 109 is the third and the fourth control or the fourth and the fifth control or the third and the fifth control of 5-control mouse and so on. For the mouse with 2 executing hot control 108, 109 and 1 locating hot control 111, the control 108, 109, 111 is the third or the fourth or the fifth control of 5-control mouse. The control 108, 109, 111 is the third or the fourth or the fifth control of 6-control mouse. Or the control 108, 109, 111 is the third or the fourth or the sixth control of 6-control mouse. Or the button 108, 109, 111 is the third or the fifth or the sixth control of 6-control mouse. Or the button 108, 109, 111 is the fourth or the fifth or the sixth control of 6-control mouse and so on.

I claim:

1. A computerized system comprising:
a computer connecting to internet having at least a processor and a memory and a voice input equipment;
a window of voice chat room downloaded thru internet;
a mouse pointing device operatively coupled to the computer and having at least one control to control the voice output to other chatters in the voice chat room.

2. The computerized system of claim 1, wherein actuation of a control causes the computer to transmit the chatter's voice input to the voice input equipment to the other chatters in the voice chat room thru internet.

3. The computerized system of claim 1, wherein actuation of a control causes the computer to stop transmitting the chatter's voice input to the voice input equipment to the other chatters in the voice chat room thru internet.

4. The computerized system of claim 1, wherein at least one of the at least one control comprises a control selected from the group of controls consisting of a button, a slider, and a wheel.

5. The computerized system of claim 1, wherein a control is the third button of 3-button mouse pointing device.

6. The computerized system of claim 1, wherein a control is the third or the fourth button of 4-button mouse pointing device.

7. The computerized system of claim 1, wherein a control is the third or the fourth or the fifth button of 5-button mouse pointing device and so on.

8. A computerized system comprising:
a computer connecting to internet having at least a processor and a memory and a voice input equipment;
a window of voice chat room downloaded thru internet;
a keyboard device operatively coupled to the computer and having at least one control to control the voice output to other chatters in the voice chat room.

9. The computerized system of claim 7, wherein actuation of a control causes the computer to transmit the chatter's voice input to the voice input equipment to the other chatters in the voice chat room.

10. The computerized system of claim 7, wherein actuation of a control causes the computer to stop transmitting the chatter's voice input to the voice input equipment to the other chatters in the voice chat room thru internet.

11. The computerized system of claim 1 or 7, wherein the voice chat room is downloaded from Yahoo website.

12. The computerized system of claim 1 or 7, wherein the voice chat room is downloaded thru Yahoo messenger.

13. The computerized system of claim 1 or 7, wherein the voice chat room is with talk frame design.
